(19) United States
(12) Patent Application Publication
(10) Pub. No.: US 2026/0233425 A1
(43) Pub. Date: Aug. 13, 2026

(54) SHAVING ASSEMBLY HAVING A RETENTION MEMBER

(71) Applicant: The Gillette Company LLC, Boston, MA (US)

(72) Inventors: Eduardo Romo Escalante, Reading (GB); Mark Peterson, Reading (GB); Robert Andrew Kearney, Reading (GB); Helena Louise Bernstein, Oxfordshire (GB); Paul John Goodall, Sandhurst (GB)

(21) Appl. No.: 19/535,225

(22) Filed: Feb. 10, 2026

Related U.S. Application Data
(60) Provisional application No. 63/756,694, filed on Feb. 10, 2025.

(51) Int. Cl. B26B 21/44; B26B 21/02; B26B 21/22

(52) U.S. Cl. CPC B26B 21/443; B26B 21/02; B26B 21/225

(57) ABSTRACT

This invention relates to a shaving assembly or hair removal device is disclosed. The shaving assembly has one or more cutting edges and one or more receiving volumes. At least one of the one or more receiving volumes comprises a shaving aid and a retention member.

### FIELD OF THE INVENTION

The present invention relates to a hair removal device or shaving assembly having a receiving volume for receiving a shaving aid, the receiving volume comprises one or more retention members.

### BACKGROUND OF THE INVENTION

Shaving assemblies have evolved to include multiple shapes and forms of use. This increase in forms of use has created a change in forces that impact the device. For example, unlike a traditional razor, a body shaving hair removal device as described herein may have one set of forces on the device when in use and a different set of forces acting on the device when in storage. Further, if the device is stored in the shower, it may come in contact with water or humidity that may impact the cutting surface and any chemistry on the device.

In razor cartridges manufactured and sold by The Gillette Company, a lubricating strip is typically provided at the back of the cartridge, after the blades. Such a lubricating strip may comprise skin conditioning agents that improve the appearance and sensation encountered by the shaver upon completion of the shaving stroke. The lubricating strip may comprise a shaving enhancement product such as a lubricant. Such strips may be attached to the cartridge. Alternatively, as described in the art, some add the composition of the strip to a receiving volume, traditionally by snap fitting the strip into the frame of the cartridge.

Improvements in chemistry have led to new and different lubricating compositions. These compositions swell when in contact with moisture and are more lubricious in nature giving the user a smoother shaving experience when compared to poly-ethyleneoxide (PEO) and polystyrene (PS) compositions. Unlike prior lubrication strips that comprise a lubricant and a carrier matrix such as a structurant or polymer matrix in which the lubricant is dispersed, newer chemistries utilize a composition wherein the lubricant may comprise a major portion of the shaving aid and the shaving aid may lack a carrier matrix. These types of compositions include pressed-pellet type shaving aids and other compositions that can be categorized as a solid emulsion.

However, due to the swelling nature and the reactivity with moisture, these new compositions are more prone to movement and increased leeching within the receiving volume. This can lead to the composition falling out of the shaving assembly or migrating, potentially due to storage conditions, thereby giving the consumer a less than desirable experience.

The present invention seeks to provide an alternative means of placing a shaving aid on a hair removal device or shaving assembly which may be a razor cartridge while additionally providing more consistent dynamics in the shave.

### SUMMARY OF THE INVENTION

In accordance with the present invention a shaving assembly or hair removal device is disclosed. The shaving assembly has one or more cutting edges and one or more receiving volumes. At least one of the one or more receiving volumes comprises a shaving aid and a retention member.

In accordance with another embodiment of the present invention a shaving assembly or hair removal device is disclosed. The shaving assembly has one or more cutting edges and one or more receiving volumes. At least one of the one or more receiving volumes comprises a shaving aid and a retention member. The shaving aid comprises of a solid emulsion with no thermoplastic structurant.

In accordance with another embodiment of the present invention a shaving assembly is described. The shaving assembly having a housing; a first cutting array mounted to the housing, the first cutting array having a plurality of non-linear cutting edges; a second cutting array mounted to the housing, the second cutting array having a plurality of non-linear cutting edges, a first receiving volume having a first retention member and a first shaving aid positioned around the first cutting array, and an external lubrication member having a second shaving aid positioned around either the first cutting array, the second cutting array or both the first cutting array and second cutting array.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a front view of one possible embodiment of a wet shaving razor.

FIG. 2 is a schematic cross-sectional side-view through x-x of a possible embodiment of the razor cartridge shown in FIG. 1.

FIG. 3 is a cross-sectional view of an alternative embodiment of the razor cartridge shown in FIG. 2.

FIG. 4 is a perspective view of an alternative hair removal device.

FIG. 5 is a cross section view of the hair removal device of FIG. 4.

FIG. 6 is a front view of an alternative hair removal device.

FIG. 7 is a cross section view of the hair removal device of FIG. 6.

FIG. 8 is a front view of an alternative hair removal device.

FIG. 9 is a cross section view of the hair removal device of FIG. 8.

FIG. 10 is a perspective view of an alternative hair removal device.

FIG. 11 is a cross section of a receiving volume of FIG. 10.

FIG. 12 is a cross section of a receiving volume having a retention member.

FIG. 13 is an alternative receiving volume having a retention member.

FIG. 14A-14C are alternative receiving volumes, each having a retention member.

### DETAILED DESCRIPTION OF THE INVENTION

The invention is applicable to razor cartridges in general that are used in a wet hair removal device. The invention is also applicable to any hair removal device having a receiving volume or housing that holds a lubricious composition or a shaving aid composition. The invention is most useful when using a composition that is a solid emulsion without the use of an internal structurant which can swell, be impacted by humidity, and may malleably move over time in the receiving volume.

In one or more embodiments, the receiving volume and shaving aid are located on a hair removal device having cutting edges within apertures on a treatment sheet. The cutting edges of the apertures in the treatment sheet may be coplanar so as to not protrude or extend beyond an upper or lower surface of the treatment sheet. Durable cutting edges can be produced from materials like ceramic or crystals like silicon, sapphire, or diamond. These materials are not ductile like metal and often are brittle, and thus they cannot be formed into e.g., a domed or convex shape, but rather are planar sheets. This type of planar treatment surface increases the treatment efficiency such as the removal of hair or dermaplaning of skin on extended flat surfaces of skin such as legs, chest and back.

The term “treatment sheet” in the personal care product of the present invention refers to a planar sheet comprising one or more apertures, preferably a plurality of apertures. The periphery or perimeter of the apertures comprise cutting edges, used for removing hair and exfoliation or other treatments on skin.

The treatment sheet is desirably flat. A “flat” material generally has planar surfaces without protrusions or indentations. As used herein, “flat” and “planar” can be used interchangeably.

The term “receiving volume” refers to a volumetric space within the hair removal device that may receive a shaving aid. The receiving volume may be in the form of one or more 3-dimensional shapes such as, e.g., cuboid, full or partial hemisphere, a full or partial hexagonal prism, a triangular prism, or any other 3-dimensional shape that is known to one of skill in the art having a depth. The receiving volume has a length, width, and a depth wherein the length is defined by the longest measurement possible and the depth is measured from the skin facing surface of the hair removal device. The length of the receiving volume is defined, at least in part by a first side wall and a second side wall opposite to the first side wall. The receiving volume may additionally have a front wall and a back wall. Additionally, the receiving volume may have a barrier structure along the skin facing surface that further defines the receiving volume while allowing the shaving aid to pass through the barrier structure through openings or other means such as diffusion. The barrier structure may serve as a retention member. The receiving volume may be determined using standard mathematical equations used to calculate volume for open vessels (cup, bowl, a pool) or closed vessels such as a box when a barrier structure is used.

The treatment sheet is also desirably rigid. A “rigid” material signifies that the material is not flexible and cannot be easily bent.

As used herein a “side wall” may be either of a first side wall or a second side wall.

The function of the treatment sheet in the personal care product is to both remove hair and to treat the skin and this is achieved by the structure of the treatment sheet noted above.

The treatment sheet of the present invention is desirably comprised of a solid, non-corroding material. The treatment sheet can be comprised of amorphous materials such as glass, crystalline materials such as silicon, diamond, sapphire, polycrystalline materials such as silicon, ceramic, or metals (e.g., steel), or any combination thereof. These materials can be shaped into rigid planar treatment sheets with apertures. Despite their rigidity, these materials can be fairly brittle. A “brittle” material is a material that generally fractures under load with little elastic or plastic deformation. The treatment sheet comprised of these materials, such as silicon and diamond, could shatter or break into pieces if the personal care product is dropped, if it is contacted with force, or takes the impact of a large force. Accordingly, the present invention increases the stability of the treatment sheet by providing a support structure. The support structure can be comprised of one or more elements. Preferably, the treatment sheet substrate is comprised of a silicon material and the cutting edges are comprised of a diamond material.

The “support structure” as used herein, signifies a structure disposed either beneath the treatment sheet, (e.g., joined to the lower surface of the treatment sheet, as will be described below), around perimeter portions of the treatment sheet (e.g., in the form of a ring), or both.

The “support structure” may comprise a support material such as a substance or material that is comprised of a fluid and cures or dries or hardens to form a solid material. Such materials can be one or more of the following: adhesive, varnish or ink, many of which are comprised of polymeric materials. These materials can be applied by spraying, printing on, rolling, or dipping, or any combinations thereof. Desirably, the support material is comprised of a material different than the material of the treatment sheet. If the support material is an adhesive, it is preferable that the adhesive solidify and bond to at least a portion of a surface of the treatment sheet. The bonded area is desirably greater than half the surface of the treatment sheet (e.g., lower surface), preferably greater than 90% of the treatment sheet surface.

The “support structure” may also be in the form of a solid material, whereby the solid material may be provided but not limited in form of a sheet, a mesh or wires. The solid material may comprise metal, ceramic thermoplastic, thermoset, or elastomeric polymers. If applied to a surface of the treatment sheet, it is desirable that the support structure is conformal or compliant to a portion or substantially all of that surface of the treatment sheet, i.e. the support structures should be in intimate contact with the surface to the treatment sheet and follow the contours of any indentations or protrusions that may be present on the surface of the treatment sheet.

If the support sheet is in this form of a “layer” or a “sheet” of material then the treatment unit desirably further comprises a support material, such as an adhesive disposed between a portion of the lower surface of the treatment sheet and the upper surface of the support sheet to join or bond the support sheet to the treatment sheet. The adhesive may be provided as a separate material that is applied to either the lower surface of the treatment sheet or the upper surface of the support sheet or both prior to joining the two together or it may be provided as a layer pre-applied to the upper surface of the support sheet so that the support sheet becomes a “self-adhesive” support sheet. Such self-adhesive materials may include self-adhesive metal tapes or polymer tapes.

A “treatment unit” of the present invention comprises a treatment sheet and at least one other support structure or material. The support structure may itself be comprised of one or more types of structures or materials and serves to support the treatment sheet providing stability, by reducing impact to the treatment sheet if an external force is applied to the treatment sheet or any component of the personal care product and by reducing damage to the treatment sheet and thus preventing injury to the consumer if the personal care product is dropped and fragments of the treatment sheet separate from the treatment unit. A hair removal device or the present invention comprises either one of a treatment unit or a razor cartridge and a handle or means to hold the treatment unit.

### Razor

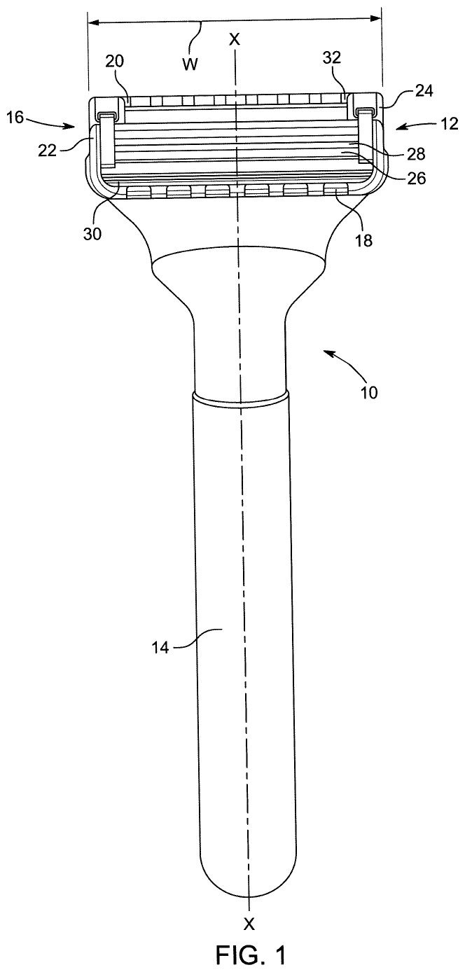

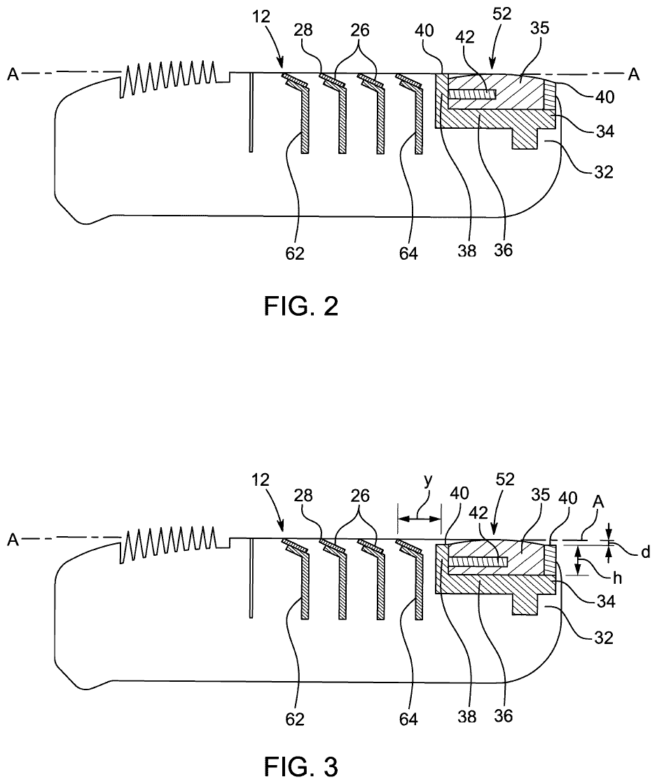

FIG. 1 shows a wet shaving razor 10 formed of a razor cartridge 12 attached to a handle 14. The razor cartridge 12 is formed of a housing 16 having a front wall 18, a rear wall 20 and first and second opposing side walls 22, 24 disposed transverse to and between the front wall 18 and rear wall 20. Two or more blades 26 with sharp cutting edges 28 are mounted within the housing 16 and extend between the first and second opposing side walls 22, 24. The tangent between cutting edges 28 of the first 62 and last 64 blade defines a shaving plane A (shown in FIGS. 2 and 3) between the guard and the cap. Five blades are shown in the embodiment of FIG. 1, however, it will be understood that more or fewer blades may be mounted within the housing 16.

A variety of razor cartridges can be used in accordance with the present disclosure. For example, U.S. Pat. No. 7,168,173 generally describes a FUSION® razor that is commercially available from The Gillette Company and which includes a razor cartridge with multiple blades. Non limiting examples of suitable razor cartridges, with and without fins, guards, and/or shave aids, include those marketed by The Gillette Company under the FUSION®, VENUS® product lines (Gillette) as well as those disclosed in U.S. U.S. Pat. Nos. 7,197,825, 6,449,849, 6,442,839, 6,301,785, 6,298,558, 6,161,288, and U.S. Patent Application Publication No. 2008/060201. Those of skill in the art will understand that the shaving aid can be used with any currently marketed razor or shaving system, including those having 2, 3, 4 or more blades. In such a case, the hair removal device is a razor, the hair removal head is a razor cartridge 10, and the one or more elongated edges are blades. Another example of a hair removal device is a scraping tool for use with a hair removal composition, i.e., a depilatory.

As shown in FIG. 1, the wet shaving razor cartridges of the present invention may be mounted on a handle 14 with the intention that the entire razor should be discarded when the sharp edges 28 of the blades 26 have become dull. Alternatively, the wet shaving cartridges of the present invention may be detachably mounted to a handle 14 so that the cartridge may be replaced on the handle 14 when the blade edges 28 have lost the sharpness required for efficient shaving. In typical cartridges, the blades 26 are usually carried by the housing 12, which is generally a molded plastic frame, and the blades 26 may then be supported to move within the frame, either independently of each other or in unison, under forces imparted on the blades 26 by the skin during shaving. In one embodiment, for support within the housing, the blades 26 are mounted fixedly within slots in a blade retaining member. In another instance, the blades may be floatably mounted within the housing. Here, the plurality of blades is supported by one or more spring loaded blade retaining members where such blades are permitted to respond to the forces encountered during shaving.

FIG. 2 shows a schematic cross-sectional side view through x-x of the razor cartridge of FIG. 1. The cap 32 is formed of a receiving volume 34 on which a shaving aid 35 may be disposed. The receiving volume 34 has a base 36 and a retention member 42 extending from a side wall 40. The retention member may be integral with the side wall or be a distinct structure that seals a hole in the side wall. The receiving volume 34 is shown in embodiments to be a separate article located within the housing 16. However, it will be appreciated that the receiving volume 34 may be formed integrally with the housing 16 in alternative embodiments.

A shaving aid 35 is disposed on the receiving volume 34 which has a retention member 42 extending from a side wall 40, as shown in FIGS. 2 and 3. The shaving aid 35 may be a pre- or post-shaving aid intended to, for example, improve the appearance and sensation encountered by the shaver upon completion of a shaving stroke.

Use of the retention member 42 increases the flexibility in choice of shaving aid 35 that can be placed on the razor cartridge. In the embodiment described herein, the retention member 42 provides the structure and a greater variety of chemical substances can be deposited on the base 36 of the receiving volume 34. In embodiments, the shaving aid is in a solid or semi-solid state and is preferably a material that can be poured onto the retention member and subsequently set, a material that can be pressed onto the retention member, or a material that can be prefabricated and bonded to the retention member.

In an embodiment, shown in FIG. 3, the shaving aid 35 may be thicker than the height of the side wall 40 such that a top surface 52 of the shaving aid 35 protrudes above the edge of the receiving volume 34 side wall 40. In the embodiment shown in FIG. 2, the top surface 52 is in line with the edge of the front wall. In all embodiments, it is expected that as the razor cartridge is used repeatedly, shaving aid will be deposited on the surface being shaved and the volume of the shaving aid will decrease.

The base 36 of the receiving volume 34 may, preferably be a generally rectangular or oval shape, and extends generally across the width, w (shown in FIG. 1), of the razor cartridge. In the embodiments shown in FIGS. 2 and 3, the side wall 40 and base 36 of the receiving volume 34 are shown to be perpendicular to one another. However, it will be appreciated that the side wall 40 could be set at a different angle relative to the base 36 and as defined above, the receiving volume may be any volumetric shape. Furthermore, the base 36 is shown to be substantially parallel to a top surface of the razor cartridge. However, it will be appreciated that the base could be set at an angle relative to the top surface of the shaving aid or that there may not be a base, e.g. if the receiving volume is in the shape of an inverse pyramid.

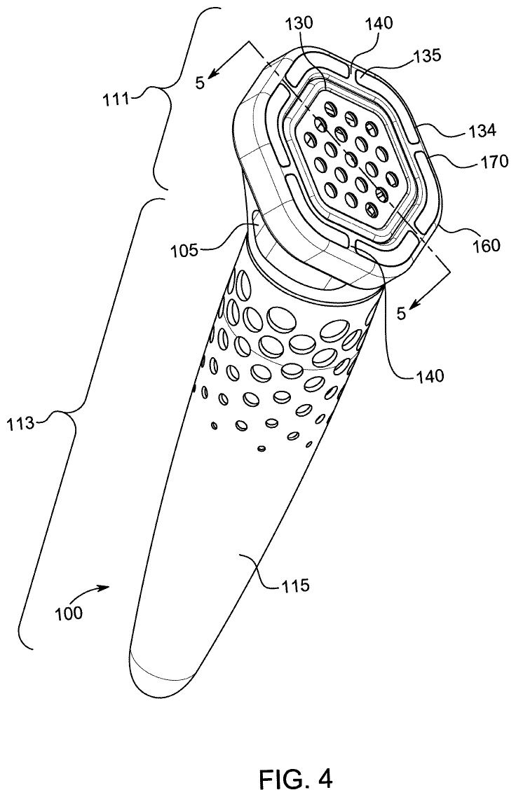

FIG. 4 shows an alternative hair removal device with one or more cutting elements. The specific device shown is intended for facial hair but may be used on any part of the body. Examples of these devices are described in application Ser. Nos. 63/177,269, 63/569,484, and 63/177,273. As shown in the Figure, the upper end of the product of the present invention generally includes, but is not limited to, a treatment sheet, a housing, support sheet and a frame member.

The present invention discloses embodiments of a treatment unit of a personal care product. Referring to FIG. 4, a side view of a personal care product 100 is shown comprising an upper product end 111 and a lower product end 113, where a handle 115 used for gripping and turning the product is generally disposed in the lower product end. The upper product end 111 comprises a treatment unit 130 disposed on or within a housing 160 over a top opening 105 of the housing 160, and a frame member 170 disposed over the treatment unit 130. As shown in FIG. 4, a receiving volume 134 having a shaving aid 135 extends along the perimeter of the treatment unit 130. The receiving volume 134 has a plurality of retention members 140.

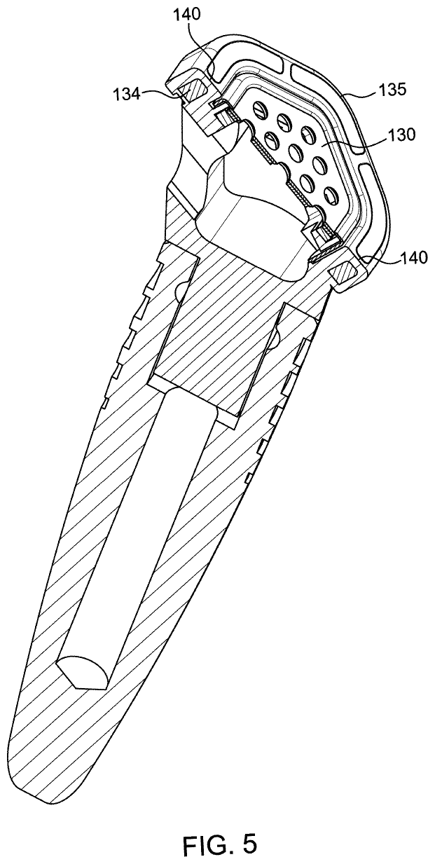

FIG. 5 shows a cross section of a receiving volume of FIG. 4. As shown in FIG. 5, the support structure comprises a receiving volume 134 having one or more retention members 140. The shaving aid 135 is placed into the receiving volume prior to setting. This allows the composition to either: wrap around the retention members when they extend from an inner surface wall of the receiving volume or to set below the body surface of the hair removal device and therefore, at least in part, under the one or more retention member(s).

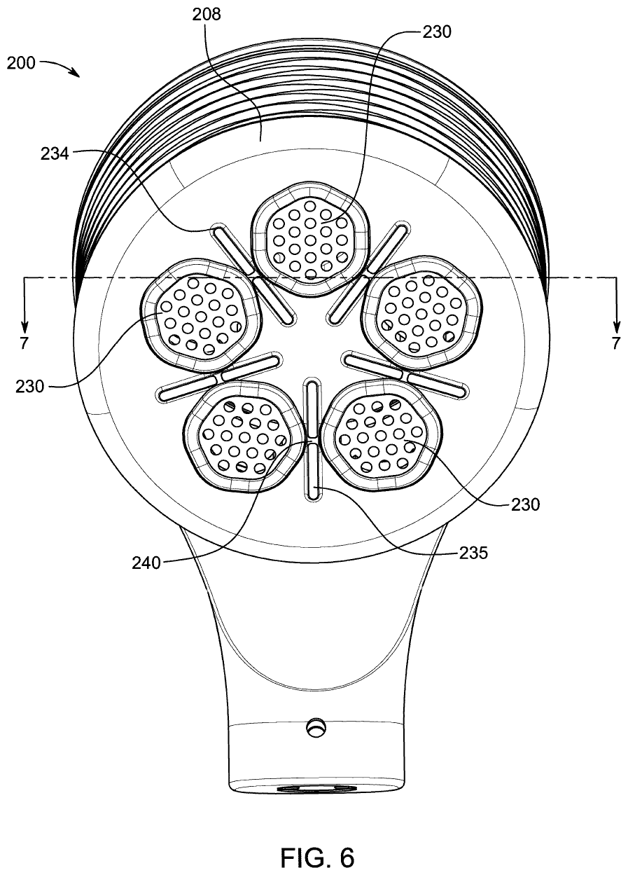

FIG. 6 shows an alternative hair removal device with one or more cutting elements. The specific device shown is intended to be used on parts of the body that are not easily accessible and therefore utilizes a handle greater than 6 inches in length (not shown). Hair removal devices such as those in FIG. 6 are described in more detail in application Ser. Nos. 19/011,939 and 18/406,803.

Referring to FIG. 6, a top view of alternative embodiment of a hair removal device 200 is illustrated. The hair removal device 200 may be connected to a handle (not shown) to reach portions of the body such as the back. Although not shown, it is understood, the hair removal device 200 may include a plurality of protrusions (not shown) positioned between a plurality of treatment sheets 230. A receiving volume 234 having a shaving aid 235 may be positioned between adjacent treatment sheets. The housing may comprise a receiving volume 234 having one or more retention members 240 and comprising a shaving aid 235. The shaving aid may deliver a lubricious composition during shaving. Additionally, the use of the shaving aid may deliver lubrication to each of the individual treatment sheets. In certain embodiments, the shaving device may further comprise one or more of an external lubrication member (not shown) that may be mounted to a housing 208 of the hair removal device 200. The external lubrication members may be in the form of extruded strips that are snapped, attached by adhesive, or press fit into the housing. The external lubrication members have a composition that is different than the composition of the shaving aid placed in the receiving volume. Accordingly, the hair removal device 200 provides a means of providing additional lubrication by either using shaving aids in one or more receiving volume, alone or in combination with additional external lubrication members. As shown in the figure, the hair removal device treatment unit may comprise a plurality receiving volumes having a shaving aid 235. In certain embodiments, adjacent receiving volumes 234 may intersect at an angle of about 30 degrees to about 120 degrees. The receiving volumes 234 need not touch to intersect, but only extend along a line that intersects a line that another one of the receiving volumes 234 extends.

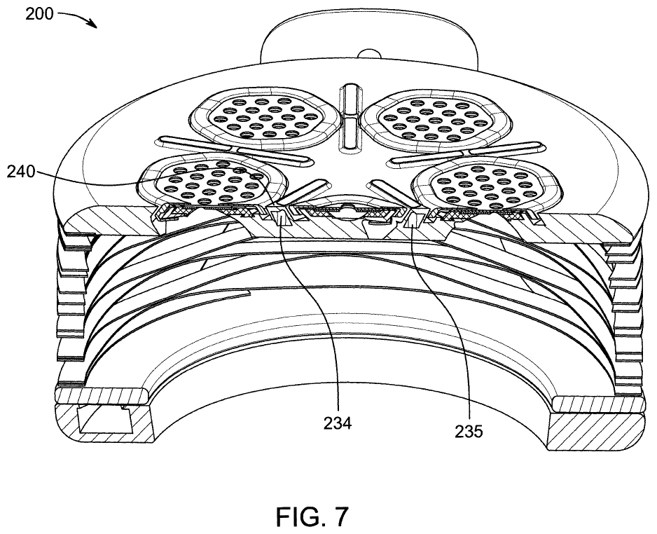

FIG. 7 shows a cross section of a receiving volume of FIG. 6. As shown in FIG. 7, the hair removal device comprises a receiving volume 234 having one or more retention members 235. The composition is placed into the receiving volume prior to setting. This allows the composition to either: wrap around the retention members when they extend from an inner surface wall of the receiving volume or to set below the body surface of the hair removal device and therefore, at least in part, under the one or more retention member(s).

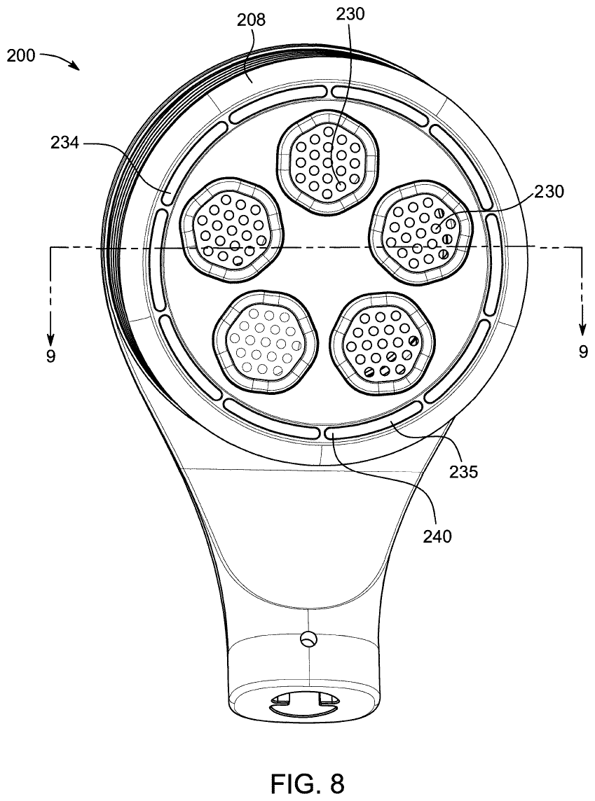

Referring to FIG. 8, a top view of alternative embodiment of a hair removal device 200 is illustrated. The hair removal device 200 may be connected to a handle (not shown) to reach portions of the body such as the back. Although not shown, it is understood, the hair removal device 200 may include a plurality of protrusions (not shown) positioned between a plurality of treatment sheets 230. A receiving volume 234 having a shaving aid 235 may be positioned on the perimeter of the hair removal device 200. The housing may comprise a receiving volume 234 having one or more retention members 240 and comprising a shaving aid 235. The shaving aid may deliver a lubricious composition during shaving. Additionally, the use of the shaving aid may deliver lubrication to each of the individual treatment sheets. Hair removal devices such as those in FIG. 8 are described in more detail in application Ser. No. 63/691,666.

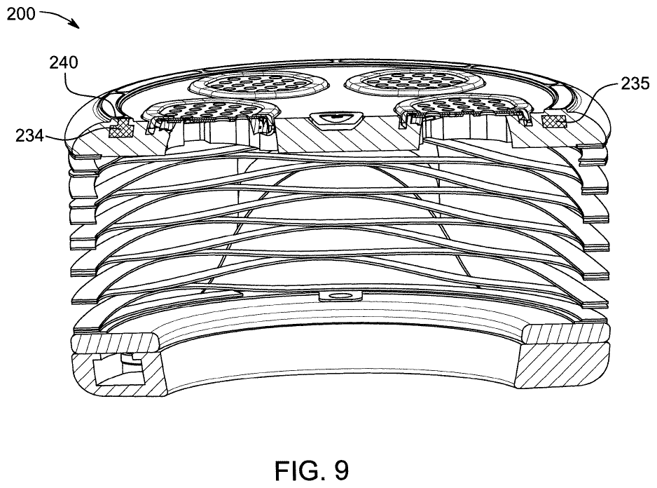

FIG. 9 shows a cross section of a receiving volume of FIG. 8. As shown in FIG. 9, the hair removal device 200 comprises a receiving volume 234 having one or more retention members 240. The shaving aid 235 is placed into the receiving volume prior to setting. This allows the composition to either: wrap around the retention members when they extend from an inner surface wall of the receiving volume or to set below the body surface of the hair removal device and therefore, at least in part, under the one or more retention member(s). As shown in the cross section, the shaving aid 235 is located both below and adjacent to the retention member 240.

### Flexible Body Shaver

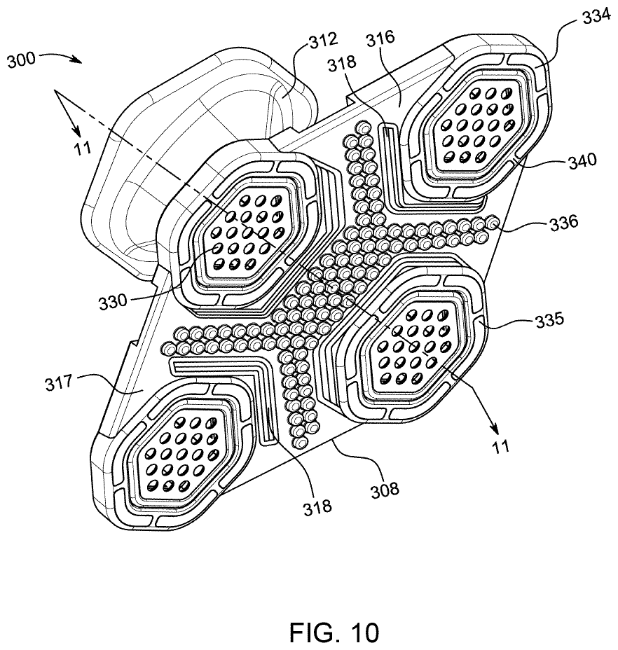

FIG. 10 shows an alternative hair removal device with one or more cutting elements. The specific device shown is intended to be used as a hair removal device for the body versus the face. As shown the hair removal device has a flexible form that may move along the contours of the human body and give the user the ability to increase pressure as needed by adding force to the flexible form. In the example shown in FIG. 10, the shaving apparatus 300 has a handle 312 that comprises of a singular shape allowing for a user's fingers to fit on either side of the handle or for the user to grasp the handle 312 on the portion away from the flexible substrate 316. The user may place their fingers so that they can bend the flexible substrate 316 by applying force upon the substrate. FIG. 10 shows the top surface 317 of the flexible substrate 316. As shown in FIG. 10, an exfoliating surface 336 may be placed between the treatment sheets 330. The exfoliating surface 336 may additionally be around one or more of the treatment sheets 330. As shown in FIG. 10, all or a portion of the top surface 317 that is between the treatment sheets 330 may further comprise a receiving volume 334 comprising a shaving aid 335 that can help with utilizing the product such as, for example, a lubricious chemical composition. The receiving volume comprises a retention member 340.

In certain embodiments, the shaving device may further comprise one or more of an external lubrication member 318 that may be mounted to a housing 308 of the hair removal device 300. The external lubrication members may be in the form of extruded strips that are snapped, attached by adhesive, or press fit into the housing. The external lubrication members have a composition that is different than the composition of the shaving aid placed in the receiving volume. Accordingly, the hair removal device 300 provides a means of providing additional lubrication by either using shaving aids in one or more receiving volume, alone or in combination with additional external lubrication members. As shown in the figure, the hair removal device treatment unit may comprise a plurality receiving volumes 334 having a shaving aid 335 located around the perimeter of one or more of the treatment sheets 330.

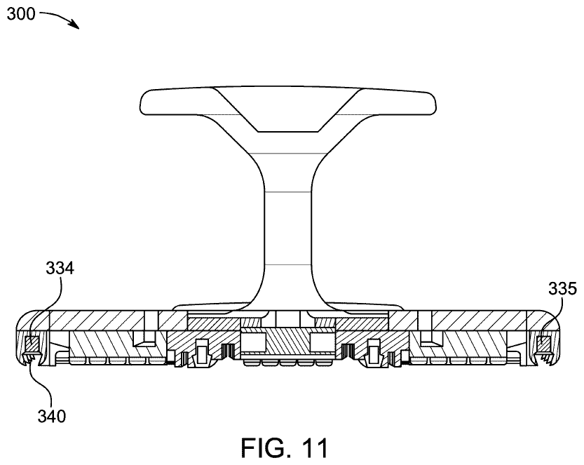

FIG. 11 is a cross section view of FIG. 10. As shown in FIG. 11, the receiving volume 334 has a retention member 340 which has shaving aid 335 both below the retention member and around the retention member.

As previously stated and shown by the cross section of FIGS. 2,3,5,7 and 9, it has been found that the use of a retention member allows for the use of improved shaving aids that have increased levels of swelling and for shaving aids that are more fluid in composition, such as solid emulsions having no internal thermoplastic structurant. The shaving aid composition placed in a receiving volume is held in place by one or more retention members. The retention members may either extend from a side wall of the receiving volume into the shaving aid, be at the body facing surface of the receiving volume, or, in both positions. The retention member may extend from one side wall to the opposing side wall crossing through the shaving aid. In an embodiment, the retention member is adjacent to the body facing side of the receiving volume, the retention member being surrounded on three sides by the shaving aid.

The main use of the retention member is to retain the shaving aid when it is exposed to different forces. It has been found that a retention member may represent up to 50% of the volume of the receiving volume, such as, e.g., 35%, 30%, 25%, 20%, 15%, 10%, 5%, or 1% to retain the shaving aid while exposing a sufficient amount of shaving aid so that it is available during shaving. In an embodiment, the receiving volume is divided into 60% to 99% of the shaving aid and up to 40% of the one or more retention members. When viewed as a cross section, the retention member thickness may be between 1% and 50% of the height of the receiving volume. Stated otherwise, the retention member, when located adjacent to the body facing surface of the receiving volume, may have up to 99% of shaving aid filling the volume under the retention member.

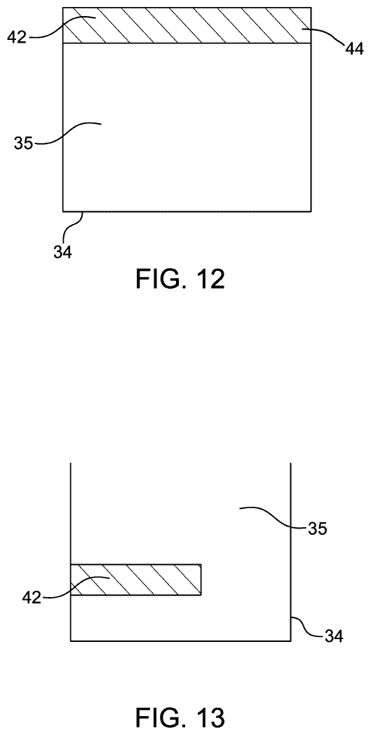

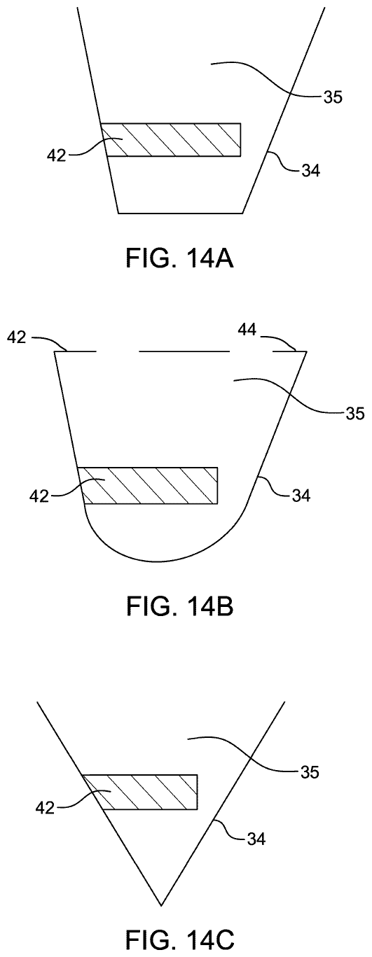

To retain the shaving aid 35 in position on the receiving volume 34, the retention member 42 may extend from a side walls as shown in FIGS. 13 and FIGS. 14A-C or across the entire surface from one side wall to the other side wall as shown in FIG. 12. When the retention member extends across the entire surface from one side wall to the other side wall as shown in FIG. 12, the retention member forms an additional structural barrier 44 that defines the volume of the retention member. Additionally, one of ordinary skill in the art recognizes that FIG. 12 is a cross section and that the material in the receiving volume must be able to exit the receiving volume leading to a retention member having openings or perforations at different cross sections along the length of the retention member. Similarly, as shown in FIG. 14B, a the volume may be further defined by a cover that serves as a retention member and a structural barrier 44 defining the volume while being included in the calculation for the volume. As shown in FIG. 14B, the structural barrier 44 comprises perforations or openings for the shaving aid to exit the receiving volume and the cover as a retention member may be used alone or in addition to other retention members as shown in FIG. 14B.

The retention member may be made of semi-rigid polymeric material having a Shore A hardness of about 50, 60 or 70 to about 90, 110 or 120. The retention member may be made of rigid polymeric material having a Shore D hardness of greater than 0, such as 50 to 120, 60 to 100, 70 to 90 or 80. In some embodiments, the retention member may be molded from the same material as the housing, for example, Noryl™ (a blend of polyphenylene oxide (PPO) and polystyrene). Alternatively, the retention member may be formed of thermoplastic elastomers (TPEs) or rubbers, examples of which include, but are not limited to: silicones, natural rubber, butyl rubber, nitrile rubber, styrene butadiene rubber, styrene butadiene, styrene (SBS) TPEs, styrene ethylene butadiene styrene (SEBS) TPEs. The retention member is made of material that is sufficiently wear resistant that even after multiple uses, the front wall of the retention member retains its initial geometry relative to the shaving plane.

As previously stated, the use of a retention member in a receiving volume is of particular use due to the nature of improved shaving aid compositions. Such shaving aid compositions either: do not utilize a thermoplastic structurant; comprise a high level of wax, petrolatum, or oil such as, e.g., polyox wax; comprise of a solid emulsion; or a combination thereof. Below is a table showing potential compositional ranges for such shaving aids and an example of a potential material that may serve that function. As shown in the table, the composition may have up to 70% of oil.

Known platform space

| Formula example | Function | % w/w |
|---|---|---|
| Behenyl Alcohol, | Structurant | 15-50 |
| stearyl alcohol | | |
| Ceteareth-20, Lauric | Wear Modifier | 0-20 |
| Acid | | |
| Cellulose Gum, silicone | Co Lubricant | 0-10 |
| block copolymers, | | |
| quaternary ammonium | | |
| compounds | | |
| Poloxamer 407, Dowsil- | Dispersant | 0-1 |
| ES 5600(silicone | | |
| polyether)* | | |
| BHT, Vit E, | Antioxidant | 0-2 |
| PEO | Lubricant | 10-45 |
| Petrolatum | Occlusive | 10-70 |
| Fragrance, Sensates, | Experiential | 0-5 |
| colorants | | |

*Available from Dow Chemicals

The description of compositions below describe materials that are preferably retained by a retention member when placed in a receiving volume on a hair removal device, especially in the absence of a thermoplastic structurant in the composition.

### Water Soluble Polymer

The shaving aid may comprise a lubricant comprising a water soluble polymer, which provides lubrication during the shave once the water soluble polymer forms at least a partial solution with water. Examples of suitable water soluble polymers may include polyethylene oxide (PEO), polyvinyl pyrrolidone, polyacrylamide, polyhydroxymethacrylate, polyvinyl imidazoline, polyethylene glycol (PEG), polyvinyl alcohol, polyhydroxyethymethacrylate, copolymers of PEO and polypropylene oxide (PPO), guars, celluloses, modified celluloses, and mixtures thereof. Preferably, the water soluble polymer is PEO, and in some examples, the water soluble polymer may be selected from high and/or low molecular weight PEO referred to in the industry as PEO and PEG respectively.

According to the present disclosure, the shaving aid may comprise a lubricant comprising from about 1% to about 99% by weight of the shaving aid, preferably at least about 15%, more preferably at least about 20%, most preferably at least about 25%, and up to about 70%, preferably up to about 60% by weight of the shaving aid. The lubricating material preferably comprises at least 50% PEO by weight of the lubricant.

The water soluble polymer (especially PEO) may have a number-average molecular weight of at least about 20,000 g/mol, preferably at least about 50,000, more preferably at least about 100,000 or from about 100,000 to about 10 million, or about 300,000 to about 8 million, or from about 1 million to about 5 million or about 2 million to about 3 million. The PEO may have a number-average molecular weight of about 5 million (all values are ±10,000 g/mol).

The PEO may include a blend of different PEOs of differing molecular weights so that the weighted-average of the component PEO's fall within the desired molecular weight range for the PEO. The PEO blend may comprise about 40% to 80% of PEO having an average molecular weight of about 5 million (e.g. POLYOX™ Coagulant; Dow Chemical) and about 60% to 10% of PEO having an average molecular weight of about 300,000 (e.g. POLYOX™ WSR-N-750; Dow Chemical). The PEO blend may comprise about 40% to 80% of PEO having an average molecular weight of about 8 million (e.g. POLYOX™ 308) and about 60% to 10% of PEO having an average molecular weight of about 300,000 (e.g. POLYOX™ WSR-N-750; Dow Chemical). The PEO blend may also advantageously contain up to about 10% (for example about 5%) by weight of a low molecular weight (i.e. MW<10,000) PEG such as PEG-100.

Suitable copolymers of PEO and PPO may have an average molecular weight of at least 5,000, preferably in the range of from 10,000 to 20,000, more preferably from 11,000 to 15,000, even more preferably from 12,000 to 13,000 and even more preferably still from 12,250 to 12,750. Without wishing to be bound by theory, the inclusion of a PEO/PPO copolymer of sufficient molecular weight is thought to further improve the lubrication properties of the shaving aid in aqueous conditions, especially in combination with a further water soluble polymer (particularly PEO) and thus prevent an undesirable feeling in use.

The PEO/PPO copolymer may advantageously be a block copolymer, preferably a tri-block copolymer having the sequence: PEO-PPO-PEO, the latter being commercially available under tradenames such as PLURACARE® (BASF) and PLURONIC® (BASF).

The PEO/PPO copolymer may have a weight ratio of PEO to PPO, of from 1000:1 to 1:1000 or from 100:1 to 1:100. The PEO/PPO copolymer is typically present at an amount of from 0.01% to 50%, preferably from 0.01% to 50%, more preferably from 2% to 40%, even more preferably from 3% to 25%, even more preferably still from 4% to 20% and most preferably from 5% to 10% by weight of the lubricating material or by weight of the shaving aid.

The shaving aid and/or water soluble polymer preferably comprises less than 5%, preferably less than 1% by weight and more preferably is/are substantially free of lathering soaps (i.e. salts of fatty C₄ to C₃₀ acids) and lathering surfactants. A lathering surfactant is defined as a surfactant which when combined with water and mechanically agitated, generates a foam or lather. Lathering surfactants may include anionic and amphoteric lathering surfactants and mixtures thereof. Anionic lathering surfactants may include sarcosinates, sulfates, sulfonate, isethionate, taurates, phosphates, lactylates, glutamates, alkali metal salts of fatty acids (i.e. soaps) having from 8 to 24 carbons, and mixtures thereof.

### Carrier Matrix

The shaving aid may be a solid under ambient conditions and may comprise a carrier matrix (also referred to herein as a “carrier”) that provides structural integrity to the shaving aid and may enhance the life of the lubricant by reducing its tendency to be mechanically eroded. Advantageously, the carrier may be solid at standard temperature and pressure. The lubricant may comprise from about 1% to about 50%, preferably from about 10% to about 40%, and more preferably from about 20% to about 40%, by weight of the carrier. In some examples, the carrier material may fall under the definition of hydrophobic compound as used herein, and in such a case, should be included for purposes of determining the amount by weight of the hydrophobic compound or mixture.

In some examples, the carrier may comprise a matrix polymer such as ethylene vinyl acetate (EVA). Examples of shaving aids comprising EVA may be found in, for example, U.S. Pat. Nos. 5,349,750 and 10,682,778. In other examples, the carrier may comprise a polymeric matrix material such as HIPS. Further examples of a matrix polymer may include ethyl cellulose; polycaprolactone (PCL); polyethylene, polypropylene; polystyrene; butadiene-styrene copolymer (e.g. medium impact polystyrene and HIPS); polyacetal; acrylonitrile butadiene-styrene (ABS) copolymer; and blends such as polypropylene/polystyrene blend, and mixtures thereof.

Shaving aids comprising HIPS are typically formed by extruding a mixture that is heated to approximately 200° C. and exposed to shear during extrusion. These high processing temperatures and high shear conditions may limit the stability of the lubricant and/or the viability of compatible stabilizing agents. As such, the use of a lower temperature processable polymer matrix material such as EVA, which requires a lower processing temperature of approximately 130° C., or a melt-formed composition may be preferable.

Melt-formed shaving aids may include a non-polymeric matrix or structurant as part of the carrier, in which the non-polymeric structurant has a melt temperature of less than 100° C. In some examples, the non-polymeric structurant may comprise a lipophilic structurant. Suitable lipophilic structurants for use herein include C₁₄ or greater, preferably C₁₄ to C₂₂, more preferably C₁₆ to C₁₈, chain length fatty acyls such as fatty acids, fatty alcohols and esters, triglycerides, waxes, and mixtures thereof. Particularly preferred are C₁₄-C₂₂ alcohols, in particular cetyl, stearyl, and behenyl alcohols and mixtures thereof.

Suitable lipophilic structurants also include natural, synthetic, and silicone waxes. As used herein, the term “wax” includes, but is not limited to, any material that is solid at 45° C., preferably at 25° C.; and are very slightly soluble in water, preferably practically insoluble in water according to the United States' Pharmacopeia (USP) definition in 31/NF 26 Vol. 2 General Notices, Page Xvii. According to that definition, this means that 1000 to 10000 parts of water are needed to dissolve 1 part solute and that more than 10,000 parts of water are needed to dissolve 1 part solute respectively.

The lipophilic structurant and/or shaving aid preferably comprises less than 5%, preferably less than 1% by weight and more preferably is substantially free of lathering soap (i.e. salts of fatty acids such as C₄-C₃₀ carboxylic acids) or lathering surfactant. A lathering surfactant is defined as a surfactant which when combined with water and mechanically agitated generate a foam or lather. Lathering surfactants include anionic and amphoteric lathering surfactants and mixtures thereof. Anionic lathering surfactants include sarcosinates, sulfates, sulfonate, isethionate, taurates, phosphates, lactylates, glutamates, alkali metal salts of fatty acids (i.e. soaps) having from 8 to 24 carbons, and mixtures thereof.

The wax may comprise natural wax, synthetic wax or mixtures thereof. Natural waxes may be plant, animal or mineral derived. Non-limiting examples of suitable natural waxes include Beeswax, Copernicia Cerifera (Carnauba) Wax, Euphorbia Cerifera (Candelilla) Wax, Jojoba Wax, Oryza Sativa (Rice) Bran Wax, Lemon peel wax, Soybean wax, Sunflower wax and mixtures thereof.

Non-limiting examples of suitable synthetic waxes include Hydrogenated Jojoba Wax, synthetic and siliconyl jojoba wax, Hydrogenated Microcrystalline Wax, Microcrystalline Wax, synthetic, siliconyl and Hydrogenated Rice Bran Wax, Ceresin, Ozokerite, Paraffin, behenyl beeswax, synthetic, siliconyl and hydrogenated Beeswax, synthetic, hydrogenated and siliconyl Candelilla Wax, synthetic, hydrogenated and siliconyl Carnauba, wax, synthetic, hydrogenated and siliconyl lemon peel wax, synthetic, siliconyl and hydrogenated soybean wax, synthetic, siliconyl and hydrogenated sunflower wax and mixtures thereof. Preferred natural and synthetic waxes are Beeswax, Microcrystalline wax, Candellila wax, Ozokerite, and mixtures thereof.

Non-limiting examples of suitable silicone waxes include Stearyoxy trimethylsilane such as DC580 wax, C₃₀-C₄₅ alkyl methicone available as DC AMS-C30 Cosmetic Wax, stearyoxymethyl silane available as DC Silkywax 10, C₂₄-C₅₄ alkyl methicone such as DC ST-Wax 30, C₃₀-C₄₅ Alkyldimethylsilyl, Polypropyl-silsesquioxane, available as DC SW-8005 resin wax, and mixtures thereof.

Particularly preferred lipophilic structurants may be selected from fatty alcohols (such as cetyl alcohol, stearyl alcohol, or behenyl alcohol), microcrystalline waxes, stearyloxy trimethylsilane and mixtures thereof.

The carrier may be relatively hydrophobic to the lubricant. The benefit agent comprising azoxystrobin may preferably be incorporated into the lubricant. Where the carrier is relatively hydrophobic to the lubricant and the lubricant forms at least a partially separate phase, the azoxystrobin may partition into the lubricant phase.

### Silicone Polyether Copolymer

The on-board liquid shaving aid composition may comprise from about 0.1% to about 60%, preferably from about 0.1% to about 20%, more preferably from about 0.1% to 5%, even more preferably from about 0.1% to about 1% by weight of a silicone polyether copolymer or mixtures thereof.

The silicone polyether copolymer may comprise from about 1% to 50%, preferably from 1% to 30%, by weight of polyethylene oxide, from about 20% to about 90%, preferably from 20% to 80% by weight of polypropylene oxide and from about 1% to about 20% by weight of silicone. Preferably the silicone polyether copolymer comprises at least about 40%, more preferably at least about 50%, most preferably at least about 60% by weight of polypropylene oxide. In addition, the silicone polyether copolymer preferably comprises at least about 10%, more preferably from at least about 15%, most preferably from about 15% to 30% by weight of polyethylene oxide. Furthermore, the silicone polyether block copolymer comprises from 1% to 20%, preferably 10% to 20%, more preferably about 15% by weight of silicone.

The silicone polyether copolymers may be block copolymers and may have a pendant graft structure or a linear structure. The silicone polyether block copolymer may comprise from 1% to 50%, preferably from 10% to 30%, more preferably about 20% by weight of polyethylene oxide. The silicone polyether block copolymer may comprise from 20% to 90%, preferably from 40% to 80%, more preferably from 50 to 80%. The silicone polyether block copolymer may comprise from 1% to 20%, preferably 10% to 20% by weight of silicone.

The silicone polyether block copolymer preferably has a ratio of polyethylene oxide units to polypropylene oxide units of from 3.0 to 0.1, preferably from 2.0 to 0.1, more preferably from 0.6 to 0.25. The silicone polyether block copolymer preferably has a ratio of polyethylene oxide units to polypropylene oxide units to silicone units of from 20:65:15.

The silicone polyether copolymer may have a molecular weight of from about 10000 to about 190000, more preferably from about 10000 to 15000. Suitable silicone polyether copolymers are available from Momentive under the SILWETS trademark products including L7210.

In one embodiment the on-board liquid shaving aid comprises a silicone polyether block copolymer and a water soluble polymer, at a weight ratio of from 1:8 to 8:1, preferably from 1:5 to 5:1, more preferably from 1:3 to 3:1 and even more preferably from 1:2 to 2:1.

In a preferred embodiment the silicone polyether copolymers suitable for use herein only contain repeating units of silicone, polyethylene oxide and polypropylene oxide. Silicone polyether copolymers comprising additional alkyl chains are preferably excluded.

### Liquid Phase

A solid shaving aid, particularly melt-formed shaving aids with a lipophilic structurant, may further comprise from about 10% to about 70%, preferably from about 10% to about 60%, more preferably from about 10% to about 40%, by weight of the shaving aid of a liquid phase. In one aspect, the liquid phase comprises a hydrophobic material or mixtures thereof. The liquid phase may provide a number of in use benefits such as lubrication, skin feel, skin health, and cooling sensation. The liquid phase is contained within the solid shaving aid by the lipophilic structurant.

In one example, the liquid phase may have a melting point of 45° C. or less, preferably 40° C. or less, even more preferably 30° C. or less, most preferably 25° C. or less. The melting point is determined according to ASTM D5440-93. Preferably the liquid phase and the hydrophobic material is liquid at 25° C. The use of a liquid phase enables the materials such as the lipophilic structurant to be readily added and mixed upon melting thereof. In another example, the liquid phase hydrophobic material or mixtures thereof may be very slightly soluble and have a melting point of 45° C. or less, as defined herein above, and be miscible with one another. In another example, the melting point of the mixture of liquid phase and the lipophilic structurant is preferably from 45° C. to 5° C. less than the melting point of the water soluble polymer.

Suitable liquid phase components for use herein include for example natural oils, synthetic oils, silicone oils, petrolatum, triglycerides, butters or mixtures thereof. As used herein, the term “oil” includes, but is not limited to any non-aqueous substance that is very slightly soluble, preferably practically insoluble in water according to the USP definition. Petrolatum may be considered as a lipophilic structurant or a liquid phase due to its complex mixture of component materials.

The oil may be selected from natural oil, synthetic oil, silicone oil and mixtures thereof. Non-limiting examples of suitable natural oils include Acetylated Castor Oil, Acetylated Hydrogenated Castor Oil, Actinidia Chinensis (Kiwi), Seed Oil, Adansonia Digitata Oil, Aleurites Moluccana Seed Oil, Anacardium Occidentale (Cashew) Seed Oil, Arachis Hypogaea (Peanut) Oil, Arctium Lappa Seed Oil, Argania Spinosa Kernel Oil, Argemone Mexicana Oil, Avena Sativa (Oat) Kernel Oil, Bertholletia Excelsa Seed Oil, Borago Officinalis Seed Oil, Brassica Campestris (Rapeseed) Seed Oil, Calophyllum Tacamahaca Seed Oil, Camellia Japonica Seed Oil, Camellia Kissi Seed Oil, Camellia Oleifera Seed Oil, Canola Oil, Caprylic/Capric/Lauric Triglyceride, Caprylic/Capric/Linoleic Triglyceride, Caprylic/Capric/Mystic/Stearic Triglyceride, Caprylic/Capric/Stearic Triglyceride, Caprylic/Capric Triglyceride, Carthamus Tinctorius (Hybrid Safflower) Seed Oil, Carthamus Tinctorius (Safflower) Seed Oil, Carum Carvi (Caraway) Seed Oil, Carya Illinoensis (Pecan) Seed Oil, Castor Oil Benzoate, Chenopodium Quinoa Seed Oil, Cibotium Barometz Oil, Citrullus Vulgaris (Watermelon) Seed Oil, Cocos Nucifera (Coconut) Oil, Cod Liver Oil, Coffea Arabica (Coffee) Seed Oil, Coix Lacryma-Jobi (Job's Tears) Seed Oil, Corylus Americana (Hazel) Seed Oil, Corylus Avellana (Hazel) Seed Oil, Cucumis Sativus (Cucumber) Oil, Cucurbita Pepo (Pumpkin) Seed Oil, Daucus Carota Sativa (Carrot) Seed Oil, Elaeis Guineensis (Palm) Kernel Oil, Elaeis Guineensis (Palm) Oil, Gossypium (Cotton) Seed Oil, Helianthus Annuus (Hybrid Sunflower) Oil, Helianthus Annuus (Sunflower) Seed Oil, Hippophae Rhamnoides Oil, Human Placental Lipids, Hydrogenated Canola Oil, Hydrogenated Castor Oil, Hydrogenated Castor Oil Laurate, Hydrogenated Castor Oil Triisostearate, Hydrogenated Coconut Oil, Hydrogenated Cottonseed Oil, Hydrogenated C12-18 Triglycerides, Hydrogenated Fish Oil, Hydrogenated Lard, Hydrogenated Menhaden Oil, Hydrogenated Mink Oil, Hydrogenated Olive Oil, Hydrogenated Orange Roughy Oil, Hydrogenated Palm Kernel Oil, Hydrogenated Palm Oil, Hydrogenated Peanut Oil, Hydrogenated Rapeseed Oil, Hydrogenated Shark Liver Oil, Hydrogenated Soybean Oil, Hydrogenated Sunflower Seed Oil, Hydrogenated Tallow, Hydrogenated Vegetable Oil, Isatis Tinctoria Seed Oil, Juglans Regia (Walnut) Seed Oil, Lauric/Palmitic/Oleic Triglyceride, Umnanthes Alba (Meadowfoam) Seed Oil, Unum Usitatissimum (Linseed) Seed Oil, Lupinus Albus Seed Oil, Macadamia Integrifolia Seed Oil, Macadamia Ternifolia Seed Oil, Maleated Soybean Oil, Mangifera Indica (Mango) Seed Oil, Marmot Oil, Melaleuca Alternifolia (Tea Tree) Leaf Oil, Melia Azadirachta Seed Oil, Melissa Officinalis (Balm Mint) Seed Oil, Menhaden Oil, Mink Oil, Moringa pterygosperma Seed Oil, Mortierella Oil, Neatsfoot Oil, Nelumbium Speciosum Flower Oil, Nigella Sativa Seed Oil, Oenothera Biennis (Evening Primrose) Oil, Olea Europaea (Olive) Fruit Oil, Olea Europaea (Olive) Husk Oil, Orange Roughy Oil, Orbignya Cohune Seed Oil, Orbignya Oleifera Seed Oil, Oryza Sativa (Rice) Bran Oil, Oryza Sativa (Rice) Germ Oil, Ostrich Oil, Oxidized Corn Oil, Oxidized Hazel Seed Oil, Papaver Orientale (Poppy) Seed Oil, Passiflora Edulis Seed Oil, Persea Gratissima (Avocado) Oil, Pistacia Vera Seed Oil, Placental Lipids, Prunus Amygdalus Amara (Bitter Almond) Kernel Oil, Prunus Amygdalus Dulcis (Sweet Almond) Oil, Prunus Armeniaca (Apricot) Kernel Oil, Prunus Avium (Sweet Cherry) Seed Oil, Prunus Cerasus (Bitter Cherry) Seed Oil, Prunus Persica (Peach) Kernel Oil, Pyrus Malus (Apple) Oil, Ribes Nigrum (Black Currant) Seed Oil, Ricinus Communis (Castor) Seed Oil, Rosa Canina Fruit Oil, Rosa Moschata Seed Oil, Salmon Oil, Salvia Hispanica Seed Oil, Santalum Album (Sandalwood) Seed Oil, Sesamum Indicum (Sesame) Seed Oil, Shark Liver Oil, Solanum Lycopersicum (Tomato) Seed Oil, Soybean Lipid, Sphingolipids, Taraktogenos Kurzii Seed Oil, Telphairia Pedata Oil, Vegetable Oil, Vitis Vinifera (Grape) Seed Oil, Zea Mays (Corn) Germ Oil, Zea Mays (Corn) Oil mineral oil and mixtures thereof.

Suitable synthetic oils include hydrocarbons, esters, alkanes, alkenes and mixtures thereof. Non-limiting examples include isopropyl palmitate, isopropyl stearate, isohexadecane, isododecane, polyglyceryl triisostearate and mixtures thereof.

Non-limiting examples of suitable silicone oils include dimethicones (including partial esters of dimethicones and fatty acids derived from natural/synthetic oils), cyclomethicones, phenylated silicones, phenyl trimethicones, trimethyl pentaphenyl trisiloxane, silicone polyether block copolymers and mixtures thereof.

The liquid phase may contain a silicone polyether. Suitable silicone polyether copolymers are disclosed above and may comprise from about 1% to 50%, by weight of PEO, from about 20% to about 90% by weight of PPO, and from about 1% to about 20% by weight of silicone. Preferably, the silicone polyether copolymer comprises at least about 40%, more preferably at least about 50%, most preferably at least about 60%, by weight of PPO. In addition, the silicone polyether copolymer preferably comprises at least about 10%, more preferably from at least about 15%, most preferably from about 15% to 30% by weight of PEO. Furthermore, the silicone polyether block copolymer comprises from 1% to 20%, preferably 10% to 20%, more preferably about 15% by weight of silicone.

Non-limiting examples of commercially available silicone oils include Dow Corning 200 fluid, Dow Corning 244, Dow Corning 245, Dow Corning 344, and Dow Corning 345, (commercially available from Dow Corning Corp.); SF-1204 and SF-1202 Silicone Fluids (commercially available from G. E. Silicones), GE 7207 and 7158 (commercially available from General Electric Co.); and SWS-03314 (commercially available from SWS Silicones Corp.), the Viscasil series (sold by General Electric Company), SF 1075 methyl-phenyl fluid (sold by General Electric Company) and 556 Cosmetic Grade Fluid (sold by Dow Corning Corp.), Silshine 151 (sold by Momentive), PH1555 and PH1560 (sold by Dow Corning) and Silwets such as Silwets 7210, 7230 and 7220 (available from by Momentive).

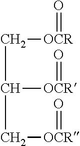

Suitable triglycerides, may have the following formula:
in which R, R′, and R″ may be the same as, or different from, one or both of the others, and in which each of R, R′, and R″ is a fatty acid and the triglyceride is solid at 25° C.

Suitable oils from which triglycerides may be formed include, but are not limited to, the oils listed herein. Suitable fatty acids for formation of triglycerides include, but are not limited to, Myristoleic acid, Palmitoleic acid, Sapienic acid, Oleic acid, Linoleic acid, α-Linolenic acid, Arachidonic acid, Eicosapentaenoic acid, Docosahexaenoic acid, Lauric acid (C₁₂), Myristic acid (C₁₄), Palmitic acid (C₁₆), Stearic acid (C₁₈), Arachidic acid (C₂₀) and mixtures thereof.

Specific sources of triglycerides suitable for inclusion herein include Shea Butter, Theobroma Cacao (Cocoa) Seed Butter, Cocoa Butter, Mangifera Indica (Mango) Seed Butter, Kokum Butter and mixtures thereof. Particularly preferred are shea butter, cocoa butter and mixtures thereof.

Preferred liquid phase components may be selected from capric and or caprylic triglycerides, olive oil, shea butter, cocoa butter, petrolatum, isopropyl isostearate, dimethicones, phenylated silicones, silicone polyether block copolymers and mixtures thereof. The silicone polyether block polymers are particularly advantageous as they may facilitate the dispersion of the water soluble polymer in the lipophilic structurant as discussed hereinafter and may also improve lubrication.

### Optional Benefit Agents

According to the present disclosure, the shaving aid may optionally further comprise one or more additional benefit agents such as those found in U.S. Pat. No. 12,194,126, Stephens et al.

### Methods of Manufacture/Processing

The shaving aid may be formed using any method known in the art such as molding (including melt-forming), pressing, impregnation, spray-coating, calendaring, and extrusion or any of the methods described in U.S. Pat. No. 12,194,126 Stephens et al.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving assembly comprising:
One or more cutting edges; and
One or more receiving volumes,
wherein at least one of the one or more receiving volumes comprises a shaving aid and a retention member.

2. The shaving assembly of claim 1 wherein the receiving volume is in the form of a ring.

3. The shaving assembly of claim 1 wherein the retention member extends from a surface wall of the receiving volume.

4. The shaving assembly of claim 1 wherein the shaving assembly comprises a housing, wherein the perimeter of the housing defines the receiving volume and wherein the receiving volume has a plurality of retention members that are adjacent to a body facing surface of the assembly.

5. The shaving assembly of claim 1, wherein the receiving volume comprises a fixed volume and wherein the retention member utilizes 50% or less of the volume.

6. The shaving assembly of claim 1, wherein the receiving volume comprises a fixed volume and wherein the retention member utilizes 5% or less of the volume.

7. The shaving assembly of claim 1, wherein the retention member is not adjacent to the body facing surface of the receiving volume.

8. The shaving assembly of claim 1, wherein the shaving aid surrounds the retention member.

9. The shaving assembly of claim 1, wherein the shaving aid is adjacent to the body facing surface and wherein the retention member is adjacent to the body facing surface and wherein a portion of the shaving aid is below the retention member.

10. The shaving assembly of claim 1 wherein the shaving aid is positioned on a plane above a shaving plane defined by the cutting edges.

11. A shaving assembly comprising:
One or more cutting edges;
One or more receiving volumes
Wherein at least one of the one or more receiving volumes comprises a shaving aid and a retention member,
wherein the shaving aid is a solid emulsion and wherein the shaving aid does not comprise a thermoplastic structurant.

12. The shaving assembly of claim 11, wherein the receiving volume is in the form of a ring.

13. The shaving assembly of claim 11, wherein the retention member extends from a surface wall of the receiving volume.

14. The shaving assembly of claim 11, wherein the perimeter of the housing defines a receiving volume and wherein the receiving volume has a plurality of retention members that are adjacent to the body facing surface of the assembly.

15. The shaving assembly of claim 11, wherein the receiving volume comprises a fixed volume and wherein the retention member utilizes 50% or less of the volume.

16. The shaving assembly of claim 11, wherein the retention member is not adjacent to the body facing surface of the receiving volume.

17. The shaving assembly of claim 11, wherein the shaving aid surrounds the retention member.

18. The shaving assembly of claim 11, wherein the shaving aid is adjacent to the body facing surface and wherein the retention member is adjacent to the body facing surface and wherein a portion of the shaving aid is below the retention member.

19. A shaving assembly comprising:
a housing;
a first cutting array mounted to the housing, the first cutting array having a plurality of non-linear cutting edges;
a second cutting array mounted to the housing, the second cutting array having a plurality of non-linear cutting edges;
a first receiving volume having a first retention member and a first shaving aid positioned around the first cutting array; and
an external lubrication member having a second shaving aid positioned around either the first cutting array, the second cutting array or both the first cutting array and second cutting array.

20. The shaving assembly of claim 19, wherein the first shaving aid is a is a solid emulsion and wherein the first shaving aid does not comprise a thermoplastic structurant.
